(19) United States
(12) Patent Application Publication
(10) Pub. No.: US 2018/0031913 A1
(43) Pub. Date: Feb. 1, 2018

(54) Borderless Display Device

(71) Applicant: Shenzhen China Star Optoelectronics Technology Co., Ltd., Shenzhen, Guangdong (CN)

(72) Inventors: Lixuan CHEN, Shenzhen, Guangdong (CN); Hu HE, Shenzhen, Guangdong (CN)

(73) Assignee: Shenzhen China Star Optoelectronics Technology Co., Ltd., Shenzhen, Guangdong (CN)

(21) Appl. No.: 14/908,286

(22) PCT Filed: Dec. 25, 2015
(86) PCT No.: PCT/CN2015/098862

§ 371 Date: Jan. 28, 2016

(30) Foreign Application Priority Data
Nov. 24, 2015 (CN) 201510825093.6

(51) Int. Cl. G02F 1/1335; H04M 1/02; G06F 1/16

(52) U.S. Cl. CPC G02F 1/133526; G02F 1/133528; G06F 1/1637; H04M 1/0266

(57) ABSTRACT

A display device, a lens assembly and a transparent material layer arranged between the lens assembly and the display device, outer surface of the lens assembly is curved, the transparent material layer at least completely covers display surface of the display device. The transparent material layer is arranged between the display device and the lens assembly to form the outer surface of the lens assembly being curved. The transparent material layer completely covers the display surface truly achieve the effect of the borderless display, and the interference is avoided to ensure the display effect. The upper polarizer of the display device is close to the curved surface of the lens assembly. The polarizer damage can be avoided because the lens assembly bound directly onto the upper polarizer of the display glass.

### BACKGROUND OF THE INVENTION

### 1. Field of the Invention

The present invention relates to a display technology field, and more particularly to a borderless display device.

### 2. The Related Arts

With the development of the technology, liquid crystal display device becomes more popular. Therefore people require higher and higher on quality as well as liquid crystal display device. Currently, more and more serious liquid crystal display device homogeneity, due to differentiation and experience degrees considerations, people are the main pursuit of larger effective display area.

In order to meet user demand, and even appeared on the market with display technology of totally borderless. As shown in FIG. 1, this technology is specific to piled with one layer inverted trapezoidal cross-section of a bevel-shaped amplifier 2 on display surface of the display device 1, the back of the bevel-shaped amplifier 2 was supported by a protective frame 3 installed outside the display device. But the fact that this combined display device is not well to achieve the display effect of borderless display device. The bevel-shaped amplifier 2 and glass of display device are vulnerable to interference due to the bevel-shaped amplifier 2 has an oblique part extending outside two sides of the display device. Therefore, not only failed to achieve borderless display, even the display effect is seriously affected.

### SUMMARY OF THE INVENTION

In view of the deficiencies of the prior art, the present disclosure provided a borderless display device and has a better display effect.

To achieve the above purpose, the technical aspect of the present disclosure is employed: a borderless display device comprises a display device, a lens assembly and a transparent material layer between the lens assembly and the display device, outer surface of the lens assembly is curved, the transparent material layer at least completely covers display surface of the display device.

Furthermore, the transparent material layer is optical cement.

Furthermore, an upper polarizer is attached to the outer surface of the lens assembly.

Furthermore, a lower polarizer is attached to bottom surface of the display device.

Furthermore, surrounding of the lens assembly protrudes over the display device, and the transparent material layer completely covers bottom surface of the lens assembly.

Furthermore, a lower polarizer is attached to the bottom surface of the display device, and edge of the lower polarizer protrudes around the display device.

Furthermore, cross-section of the lens assembly is a bow.

Possibly, the borderless display device further comprises a frame, and the frame is close to end faces of the display device and the lens assembly.

Furthermore, a step part is arranged in an inner wall of top of the frame, and bottom surface of the lens assembly and the display surface are the same size, and a flange protrudes from top end of the lens assembly to surrounding of the lens assembly, and the flange is close to the step part.

Furthermore, an angle of the end face of the lens assembly and the bottom surface is not less than 90°.

The transparent material layer is arranged between the display device and the lens assembly to form the outer surface of the lens assembly being curved. The transparent material layer completely covers the display surface truly achieve the effect of the borderless display, and the interference is avoided to ensure the display effect. The upper polarizer of the display device is close to the curved surface of the lens assembly. The polarizer damage can be avoided because the lens assembly bound directly onto the upper polarizer of the display glass. The optical glue never influences the upper polarizer again, and the upper polarizer can play its role well. It is more convenient to pile the upper polarizer with the curved surface of the lens assembly.

### BRIEF DESCRIPTION OF THE DRAWINGS

FIG. 1 is a structure diagram of a prior art borderless display device.

FIG. 2 is a structure diagram of embodiment 1 according to the borderless display device of the present disclosure.

FIG. 3 is a structure diagram of embodiment 2 according to the borderless display device of the present disclosure.

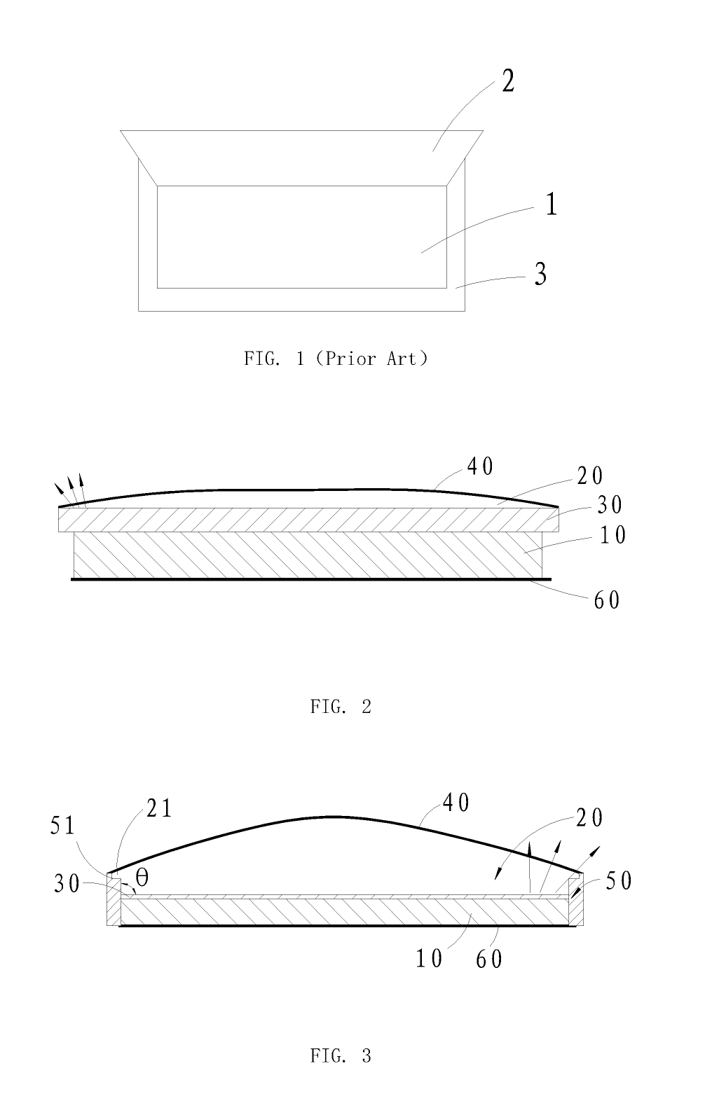

### DETAILED DESCRIPTION OF PREFERRED EMBODIMENTS

In order to make the objects, technical solutions and advantages of the present disclosure will become apparent from, the accompanying drawings and the following embodiments, the present disclosure will be described in further detail. It should be understood that the specific embodiments described herein only to explain the present disclosure and are not intended to limit the present disclosure.

### EXAMPLE 1

Referring to FIG. 2, the borderless display device comprises a display device 10, a lens assembly 20 and a transparent material layer 30 between the lens assembly 20 and a display device 10, the outer surface of the lens assembly 20 is curved, the transparent material layer 30 at least completely covers the display surface of the display device 10.

The lens assembly 20 has high visible light transmittance by designing the curvature of the outer surface. The small curvature of curved surface can reduce the risk of screen distortion. Users can see a borderless display device and have better display effect due to the curved outer surface of a lens assembly 20. A transparent material layer 30 is between the display device 10 and the lens assembly 20. The interference probability of the display device is greatly reduced, and the light from the edge of the lens assembly 20 diverges after refracting.

Furthermore, the transparent material layer 30 is optical glue, and the display device 10 is liquid crystal panel. An upper polarizer 40 is attached to the outer surface of the lens assembly 20, and a lower polarizer 60 is attached to the bottom surface of the display device 10. The upper polarizer 40 is arranged on the outer surface of the lens assembly 20 to avoid damage when the upper polarizer is equipped between an optical glass and the lens assembly 20. Not only it is easier to adhere the upper polarizer 40 but also it reduces the influence of the upper polarizer 40 when the transparent material layer 30 setting on the optical glass.

In this embodiment, the area of lens assembly 20 is larger than the display surface of display device 10, the cross-section of the lens assembly 20 is a bow and the surrounding of the lens assembly protrudes over the display device 10. A transparent material layer 30 completely covers the bottom surface of the lens assembly 20. The size which the lens assembly 20 protrudes to the display device 10 can effectively avoid the phenomenon of the dark side in the active area . . . At same time, edge of lower polarizer 60 extends around a display device 10 to improve the utilization of the incident light.

### EXAMPLE 2

Referring to FIG. 3, different from example 1, the borderless display device of this embodiment comprises a frame 50, but the frame of the screen does not appear. Significantly, the frame is close to the end face of the display device and the lens assembly 20, the curved surface of top of the lens assembly 20 protrudes over the frame 50 so that light from the edge of the display device 10 after refracting covers the frame 50 to achieve the borderless effect.

A step part is arranged in an inner wall of top of the frame, and bottom surface of the lens assembly and the display surface are same size, and a flange protrudes from top end of the lens assembly to surrounding of the lens assembly. The flange is close to the step part, so that the lens assembly 20, the display device 10 and the frame 50 can fit together nicely. The flanges 21 can be formed by polished. The angle of the end face of the lens assembly and the bottom surface is not less than 90° to avoid affecting the display effect.

Furthermore, the upper polarizer 40 can protrude over the frame 50 or the display surface, so that it can be sandwiched between the end surface of the lens assembly 20 and the frame 50. The frame 50 and the lens assembly 20 are used to assisting positioning The difficulty of lower polarizer 40 piled with the curved surface of the lens assembly 20 is reduced.

The transparent material layer is arranged between the display device and the lens assembly to form the outer surface of the lens assembly being curved. The transparent material layer completely covers the display surface truly achieve the effect of the borderless display, and the interference is avoided to ensure the display effect. The upper polarizer of the display device is close to the curved surface of the lens assembly. The polarizer damage can be avoided because the lens assembly bound directly onto the upper polarizer of the display glass. The optical glue never influences the upper polarizer again, and the upper polarizer can play its role well. It is more convenient to pile the upper polarizer with the curved surface of the lens assembly.

The above description is only the specific embodiment of the present application, it should be noted that those of ordinary skill in the art, in this application without departing from the principles of the premise, but also a number of improvements and modifications can be made, these improvements and modifications are to be considered the scope of the present application.

What is claimed is:

1. A borderless display device, comprising a display device, a lens assembly and a transparent material layer arranged between the lens assembly and the display device, outer surface of the lens assembly is curved, the transparent material layer at least completely covers display surface of the display device.

2. The borderless display device according to claim 1, wherein the transparent material layer is optical cement.

3. The borderless display device according to claim 1, wherein an upper polarizer is attached to the outer surface of the lens assembly.

4. The borderless display device according to claim 1, wherein a lower polarizer is attached to bottom surface of the display device.

5. The borderless display device according to claim 1, wherein surrounding of the lens assembly protrudes over the display device, and the transparent material layer completely covers bottom surface of the lens assembly.

6. The borderless display device according to claim 3, wherein surrounding of the lens assembly protrudes over the display device, the transparent material layer completely covers bottom surface of the lens assembly.

7. The borderless display device according to claim 5, wherein a lower polarizer is attached to the bottom surface of the display device, and edge of the lower polarizer protrudes around the display device.

8. The borderless display device according to claim 5, wherein cross-section of the lens assembly is a bow.

9. The borderless display device according to claim 1, further comprises a frame, and the frame is close to end faces of the display device and the lens assembly.

10. The borderless display device according to claim 9, wherein a step part is arranged in an inner wall of top of the frame, and bottom surface of the lens assembly and the display surface are the same size, and a flange protrudes from top end of the lens assembly to surrounding of the lens assembly, and the flange is close to the step part.

11. The borderless display device according to claim 9, wherein an angle of the end face of the lens assembly and the bottom surface is not less than 90°.

12. The borderless display device according to claim 2, further comprises a frame, and the frame is close to end faces of the display device and the lens assembly.

13. The borderless display device according to claim 12, wherein a step part is arranged in an inner wall of top of the frame, and bottom surface of the lens assembly and the display surface are same size, and a flange protrudes from top end of the lens assembly to surrounding of the lens assembly, and the flange is close to the step part.

14. The borderless display device according to claim 12, wherein an angle of the end face of the lens assembly and the bottom surface is not less than 90°.

15. The borderless display device according to claim 3, further comprises a frame, and the frame is close to end faces of the display device and the lens assembly.

16. The borderless display device according to claim 15, wherein a step part is arranged in an inner wall of top of the frame, and bottom surface of the lens assembly and the display surface are the same size, and a flange protrudes from top end of the lens assembly to surrounding of the lens assembly, and the flange is close to the step part.

17. The borderless display device according to claim 15, wherein an angle of the end face of the lens assembly and the bottom surface is not less than 90°.

18. The borderless display device according to claim 4, wherein further comprises a frame, and the frame is close to end faces of the display device and the lens assembly.

19. The borderless display device according to claim 18, wherein a step part is arranged in an inner wall of top of the frame, and bottom surface of the lens assembly and the display surface are the same size, and a flange protrudes from top end of the lens assembly to surrounding of the lens assembly, and the flange is close to the step part.

20. The borderless display device according to claim 18, wherein an angle of the end face of the lens assembly and the bottom surface is not less than 90°.
